(19) United States
(12) Patent Application Publication
(10) Pub. No.: US 2014/0109204 A1
(43) Pub. Date: Apr. 17, 2014

(54) AUTHENTICATION SYSTEM VIA TWO COMMUNICATION DEVICES

(71) Applicant: ALCATEL LUCENT, Paris (FR)

(72) Inventors: Serge Papillon, Nozay (FR); Antony Martin, Nozay (FR)

(21) Appl. No.: 14/119,133

(22) PCT Filed: Jun. 15, 2012
(86) PCT No.: PCT/EP2012/061482

§ 371 Date: Nov. 25, 2013

(30) Foreign Application Priority Data
Jun. 28, 2011 (FR) 1155751

(51) Int. Cl. G06F 21/35; H04L 29/06

(52) U.S. Cl. CPC G06F 21/35; H04L 63/0838
USPC 726/5

(57) ABSTRACT

To authenticate a user possessing a first communication terminal (TC1) and a second communication terminal (TC2), the first terminal being connected to an application server (SApp) in order to access a service, this application server being connected to an authentication server (SAuth) capable of communicating with the second terminal, the authentication server (SAuth) receives a user identifier (IdU) transmitted from the first terminal and identifies the second terminal based on the received identifier. The server generates coding data (DonC) and transmits it to one of the two terminals, and transmits a command to the other one of the two terminals to invite the user to provide a set of data (EnsD) using the coding data received by said one of the two terminals. The server compares the set of data with secret data (DonS) using the coding data, in order to allow the user access to the application server (SApp).

The present invention pertains to an authentication of a user via two communication devices.

At present, it is risky to execute sensitive transactions online, involving, for example, an authentication from computers in Internet cafés or public places. The unreliable nature of these machines is an opportunity for hackers to collect sensitive information, such as access codes. A simple keylogger can transmit secret information, such as access codes, passwords, or PIN numbers. Malevolent software, such as malware, can automate identify theft on a large scale and execute unauthorized transactions by impersonating a given user.

There are an increasing number of resources available online that may require identification and authentication before authorization: e-banking, e-commerce, social networking applications, and applications hosted and distributed throughout the network. Furthermore, entities such as monitors or video projectors may become means of authentication. This is why identity-unifying solutions are essential to aid in Internet-based identification and authentication with a single identity or a few identities. However, these solutions do not guarantee the authentication of a user.

For all of these reasons, sensitive information such as persistent passwords or PIN codes must not be entered on unreliable machines.

To remedy the aforementioned drawbacks, a method for authenticating a user possessing a first communication terminal and a second communication terminal, the first communication terminal being connected to an application server in order to access a service, the application server being connected to an authentication server capable of communicating with the second communication terminal and the first communication terminal, comprises the following steps within the authentication server:

after receiving a user identifier transmitted from the first communication terminal, identifying the second communication terminal from the received user identifier,

generating coding data,

transmitting the generated coding data to either the first or second communication terminal,

transmitting a command to the other one of the first and second communication terminals to prompt the user to provide a set of data by using the coding data received by said either the first or second communication terminal, and

comparing the data set provided by the user and transmitted by said other one of the first and second communication terminals with secret data using the generated coding data, in order to allow the user access to the application server via the first communication terminal.

Advantageously, the invention offers a reliable way to use a PIN code or password from two communication terminals that are unreliable by nature. This way, any malware installed in a communication terminal such as a computer or mobile telephone is prevented from retrieving persistent sensitive information. The user may then use a password without fear of being compromised.

According to another characteristic of the invention, the authentication server can implicitly identify the second communication terminal based on the received user identifier, the authentication server having previously saved an identifier of the second communication terminal as a match for the user identifier.

According to another characteristic of the invention, the authentication server can explicitly identify the second communication terminal, the user having filled out the user identifier with an additional piece of information corresponding to an identifier of the second communication terminal.

According to another characteristic of the invention, after receiving an initial identifier provided by the user and transmitted from the second communication terminal, the authentication server deduces the user's identity from the received initial identifier, generates the user identifier, which is a temporary identifier, temporarily saves the temporary identifier as a match for an identifier of the second terminal and transmits the user identifier to the second communication terminal.

According to another characteristic of the invention, after receiving a request transmitted from the second communication terminal, the authentication server deduces the users identity from an identifier of the second communication terminal associated with the request, generates the user identifier, which is a temporary identifier, temporarily saves the temporary identifier as a match for the identifier of the second terminal and transmits the user identifier to the second communication terminal.

According to another characteristic of the invention, the purpose of the coding data is to establish a match between two sets of characters, in order for the user to provide a series of characters in a scrambled fashion via the set of data.

According to another characteristic of the invention, the coding data is dynamic, and changes every time a predetermined number of characters has been provided by the user.

According to another characteristic of the invention, the coding data is transmitted to either the first or second communication terminal in text form, in table form, in image form, or in voice form.

According to another characteristic of the invention, the secret data is a password, a code, or a bank card number.

The invention also pertains to an authentication server for authenticating a user who possesses a first communication terminal and a second communication terminal, the first communication terminal being connected to an application server in order to access a service, the application server being connected to the authentication server capable of communicating with the second communication terminal and the first communication terminal, the authentication server comprising:

means for identifying, after receiving a user identifier transmitted from the first communication terminal, the second communication terminal from the received user identifier,

means for generating the coding data,

means for transmitting the generated coding data to either the first or second communication terminal,

means for transmitting a command to the other one of the first and second communication terminals to prompt the user to provide a set of data by using the coding data received by said either the first or second communication terminal, and

means for comparing the data set provided by the user and transmitted by said other one of the first and second communication terminals with secret data using the generated coding data, in order to allow the user access to the application server via the first communication terminal.

The invention also pertains to a computer program capable of being implemented within a server, said program comprising instructions which, whenever the program is executed within said server, carry out the steps according to the inventive method.

The present invention and the benefits thereof shall be better understood upon examining the description below, which makes reference to the attached figures, in which:

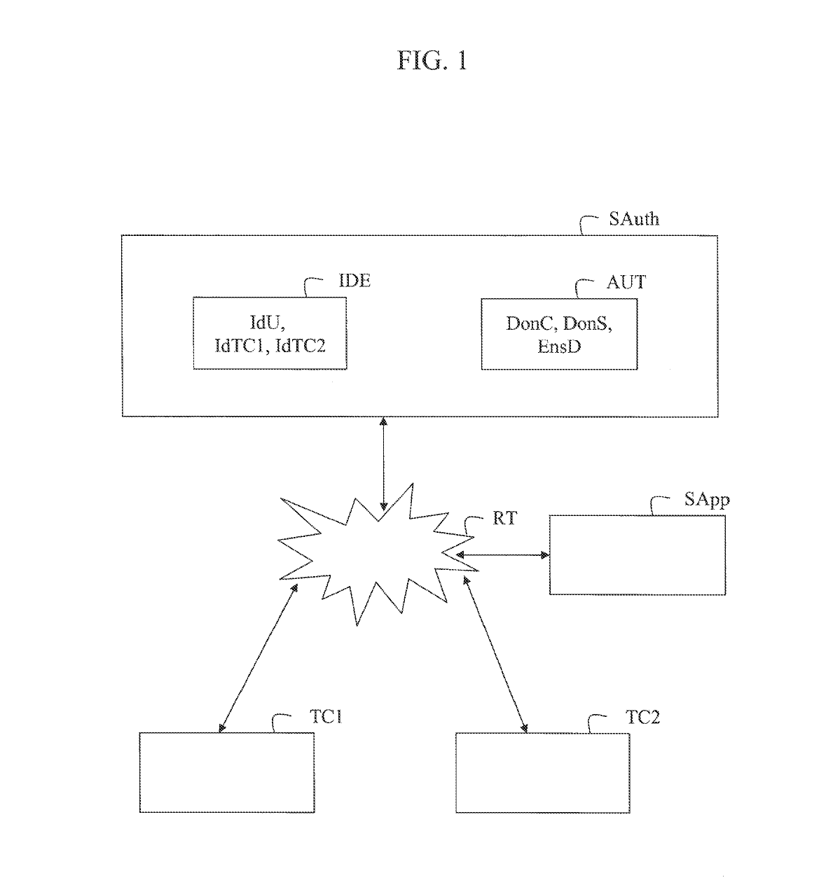

FIG. 1 is a schematic block diagram of a communication system according to one embodiment of the invention,

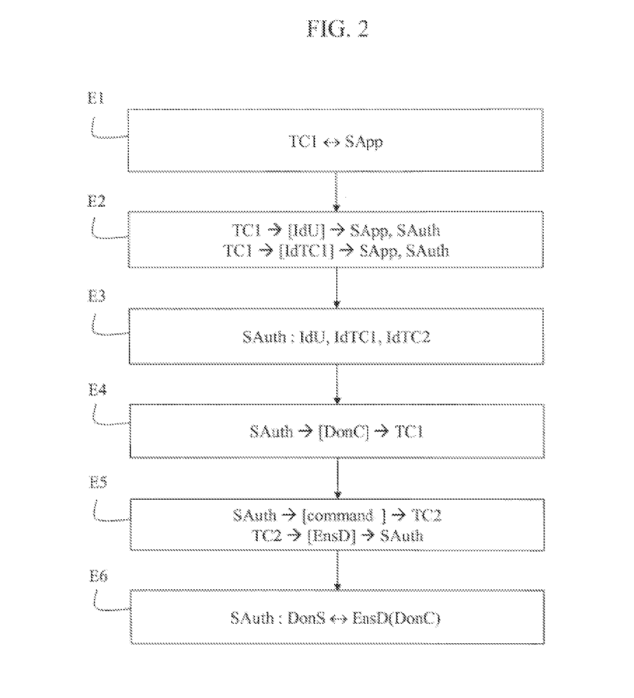

FIG. 2 is an algorithm of an authentication method of the user according to one embodiment of the invention, and

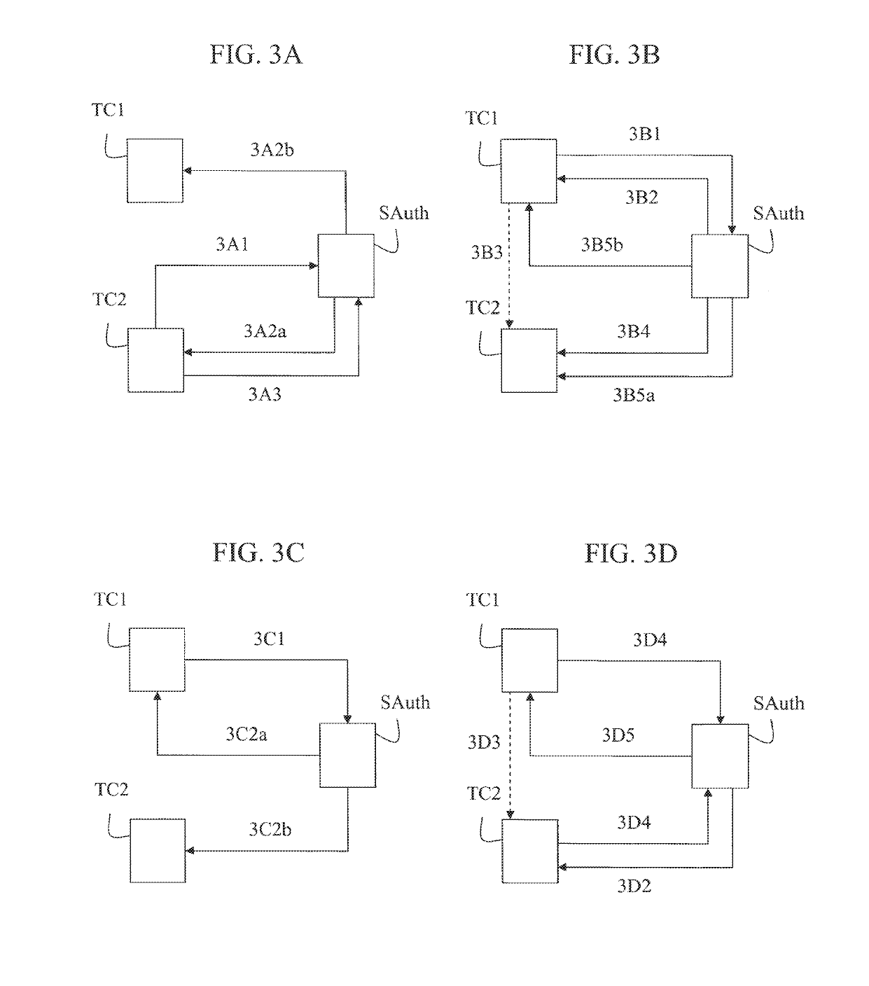

FIGS. 3A, 3B, 3C and 3D illustrate different example embodiments of the invention.

With reference to FIG. 1, a communication system comprises an application server SApp, an authentication server SAuth, a first communication terminal TC1 and a second communication terminal TC2, the application server SApp and the authentication server SAuth being capable of communicating with one another and with both the first communication terminal TC1 and the second communication terminal TC2 over a telecommunications network RT.

The telecommunication network RT may be a wired or wireless network, or a combination of wired and wireless networks.

In one example, the telecommunications network RT is a high-speed IP (“Internet Protocol”) packet network, such as the Internet or an intranet.

In another example, the telecommunications network RT is a TDM (“Time Division Multiplexing”) network or a private network specific to a company supporting a proprietary protocol.

A communication terminal TC1 or TC2 of a user is connected to the application server SA over the telecommunications network RT.

In one example, a communication terminal is a personal computer directly linked by modem to an xDSL (“Digital Subscriber Line”) or ISDN (“Integrated Services Digital Network”) link connected to the telecommunication network RT.

In another example, a communication terminal is a mobile cellular radiocommunication terminal, linked to the telecommunication network by a radiocommunication channel, for example of the GSM (“Global System for Mobile communications”) or UMTS (“Universal Mobile Telecommunications System”) type.

In another example, a communication terminal comprises an electronic telecommunication device or object that may be a personal digital assistant (PDA) or a smartphone, capable of being connected to an antenna on a public wireless local area network WLAN, a network using the 802.1x standard, or a wide area network using the WIMAX (“Worldwide Interoperability Microwave Access”) protocol, connected to the telecommunication network.

For example, the communication terminal is a TDM landline telephone or a voice-over-IP landline telephone. According to another example, the communication terminal is a POE (“Power Over Ethernet”) landline telephone that is powered via an Ethernet connection.

The application server SApp is a server that provides a given service to a user after an identification and authentication of the user.

According to one example, the application server SApp is a Web server hosting a website that provides a given service, such as an e-commerce site.

According to another example, the application server SApp is a voice server that provides a given service, such as, for example, to purchase a given product.

The application server SApp contains, within a database, information about various users, and particularly a profile for each user containing an identifier DonS such as a password or code or particular sequence of alphanumeric characters such as a bank card number, an identifier IdTC1 of the first communication terminal, and an identifier IdTC2 of the second communication terminal. The identifiers TC1 and TC2 may be addresses of terminals, such as IP or MAC (“Media Access Control”) addresses, or telephone numbers, or any type of data that makes it possible to identify the terminal.

The authentication server SAuth comprises an identification module IDE, and an authentication module AUT. In the remainder of the description, the term module may designate a device, a software program, or a combination of computer hardware and software, configured to execute at least one particular task.

The identification module IDE retrieves an identifier IdU provided by the user in order to access a particular resource, such as a service delivered by a website.

The user identifier IdU may be a persistent or single-use login.

The user may explicitly or implicitly request a temporary identifier IdU, i.e. a single-use identifier. An explicit request may be made to the authentication server by transmitting it an initial identifier, for example a persistent identifier, which makes it possible to identify the user, the generating authentication server, and then a temporary identifier. An implicit request may be made to the authentication server from a communication terminal already known to the server, meaning one whose identifier associated with the request is already known to the server, which deduces from it the users identity and then generates a temporary identifier.

The identification module IDE pairs together two communication terminals. Pairing may be done explicitly or implicitly.

For implicit pairing, the user identifier IdU entered by the user from a first communication terminal may be used to locate an identifier IdTC2 of a second communication terminal, additionally optionally using an identifier IdTC1 of the first communication terminal. The server SAuth thereby locates the match between the terminals' identifiers IdTC1 and IdTC2 based on the user's identifier IdU.

For explicit pairing, the user enters the user identifier IdU with an additional piece of information that corresponds to an identifier IdTC2 of the second communication terminal.

The identification module IDE identifies and selects the terminals desired by the user in order to enter secret data DonS via one of the terminals in order to obtain coding data DonC via the other one of the terminals. This identification may be carried out based on the user's preferences provided earlier by that user, or may be deduced based on the context, depending on the type of terminal used by the user at the time when access is requested from the application server SApp.

The authentication module AUT generates coding data DonC used to authenticate the user. The purpose of the coding data DonC is to establish a match between two sets of characters, in order for the user to provide, in a scrambled manner, a series of characters that corresponds to secret information such as a code or password. For example, the coding data contains indications to make a connection between two sets containing the digits 1 to 9, each digit of one set corresponding to a different digit of the other set.

The authentication module AUT transmits the coding data DonC to one of the communication terminals selected by the identification module IDE. The communication terminal then provides the coding data to the user, in different possible formats, depending on the communication terminal's capabilities, and optionally depending on the user's preferences. According to one example, the coding data is displayed on a screen of the communication terminal, in text form, in table form, or in image form. According to another example, the coding data is spoken to the user via a speaker of the communication terminal.

The authentication AUT transmits a command to the other one of the communication terminals selected by the identification module IDE to invite the user to provide a set of data that corresponds to secret data DonS using the previously received coding data DonC. The communication terminal receiving this command comprises means for interpreting that command and for inviting the user to enter secret information via a graphical or voice interface. For example, the communication terminal comprises an application run in the background that interprets every message received from the authentication server SAuth. This application may be an application managed by the communication terminal's operating system, or may be managed by a SIM card, for example in the event that the terminal is a GSM mobile telephone, in the form of an STK (“SIM Application Toolkit”) application capable of communicating directly with entities of the telecommunication network, and particularly with the authentication server SAuth.

It is assumed that the two communication terminals receive the coding data DonC and the command to provide the secret data DonS at roughly the same time.

In one example for illustrative purposes, the authentication server SAuth transmits the coding data to the first communication terminal TC1, which is a personal computer connected to a website hosted by the application server SA. The first terminal TC1 displays the coding data in the form of a three row by three column grid representing a number pad, in which the digits 1 to 9 are arranged in descending order from left to right and top to bottom. Furthermore, the authentication server SAuth transmits a command to the second communication terminal TC1, which is a smartphone. The second terminal TC2 displays a three row by three column grid representing a number pad, in which the digits 1 to 9 are arranged in ascending order from left to right and top to bottom. The user may deduce from this that the digit 1 corresponds to the digit 9, that the digit 2 corresponds to the digit 8, etc. If the secret data to be entered is a four-digit code, such as 3589, the user may enter all of the data, which is the sequence 7521.

In one embodiment, the coding data is dynamic and may thereby change over time. In a first example, the match between the two sets of characters changes every time the user provides a character, or every time a predetermined number of characters has been provided by the user. For this purpose, the terminal on which the characters are entered may transmit a message to the authentication server, which transmits new coding data to the terminal that is displaying the coding data. In a second example, the match between the two sets of characters changes whenever one or more intervals of time expires. As the terminal displaying the coding data and the authentication server have the same coding data in common, the authentication server will be able to interpret the character sequence entered by the user, a date being, for example, associated with each character entered by the user by an application of the terminal.

The authentication module AUT decodes the characters entered by the user with the help of the coding data DonC in order to check if the sequence of characters entered, i.e. the set of data EnsD entered, corresponds to the secret data DonS requested of the user for his or her authentication.

In one embodiment, the authentication server SAuth and the application server SApp are integrated into a single entity.

With reference to FIG. 2, the authentication method according to one embodiment of the invention comprises steps E1 to E6 executed automatically within the communication system.

In step E1, the user connects to an application server SApp via a first communication terminal TC1 and wishes to access a service delivered by the application server SApp. The server SApp uses an authentication system to allow access to the service to the user, by inviting the user to provide a user identifier IdU, such as a user name or a “login”, and secret data DonS, such as a password or a code or a particular sequence of characters, such as a bank card number.

In step E2, the user enters a user identifier IdU and the first communication terminal TC1 transmits the identifier IdU to the application server SApp, which retransmits it to the authentication server SAuth. In one variant, the first terminal TC1 directly transmits the identifier IdU to the authentication server SAuth.

As previously described, the user may explicitly or implicitly request a temporary user identifier IdU, i.e. a single-use identifier, from the authentication server. Employing a temporary identifier allows the user to avoid giving out his or her persistent identifier.

An explicit request may be made from the authentication server by transmitting to it an initial identifier, for example a persistent identifier, from a second communication terminal TC2. The authentication server deduces the users identity from the received initial identifier, and generates the user identifier IdU which is a temporary identifier. The authentication server then temporarily saves the temporary identifier as a match for an identifier IdTC2 of the second terminal, the identifier IdTC2 being, for example, deduced from the context of the explicit request.

An implicit request may be made to the authentication server from a second communication terminal TC2 already known to the authentication server, i.e. the one whose identifier IdTC2 associated with the request is already known to the server. The authentication server deduces the users identity from the identifier IdTC2 of the second terminal, and generates the user identifier IdU which is a temporary identifier. The authentication server then temporarily saves the temporary identifier as a match for an identifier IdTC2 of the second terminal. In this case, it is assumed that the authentication server already had in memory a match between the identifier IdTC2 and a persistent identifier of the user.

In either case, for an implicit or explicit request, the authentication server transmits the temporary user identifier to the second communication terminal TC2, and the user can then enter the user identifier IdU from the first communication terminal TC1.

Optionally, an identifier TC1 of the first communication terminal TC1 is transmitted to the authentication server SAuth.

In step E3, the authentication server SAuth pairs the first communication terminal TC1 with a second communication terminal TC2.

For that purpose, the identification module IDE locates in a database an identifier IdTC2 of the second communication terminal with the help of the user identifier IdU.

As previously described, the pairing may be implicit, with the identifier IdTC2 of the second terminal being located automatically with the help of the user identifier IdU, and optionally with the help of the identifier IdTC1 of the first terminal. The identifier IdTC1 of the first terminal may affect the choice of the second terminal, based on the user's preferences and potentially the context associated with each of the terminals. The pairing may also be explicit, with the identifier IdTC2 of the second terminal being located with the help of the user identifier IdU entered with an additional piece of information that matches an identifier IdTC2 of the second communication terminal. In this case, the user himself or herself designates the second communication terminal that he or she wishes to use.

If the user identifier IdU is a temporary identifier, it is assumed that the user is opting for implicit pairing, although the user can opt for explicit pairing anyway.

The authentication server SAuth then assigns a role to both of the communication terminals, dedicating one of them to providing coding data to the user and the other one to inviting the user to enter his or her secret data, with both the first terminal and the second terminal potentially playing either role. For the sake of clarity, it is assumed in the remainder of the method that the second communication terminal TC1 is selected to provide coding data to the user, while the second communication terminal TC2 is selected in order to invite the user to enter secret data.

In step E4, the authentication module AUT generates coding data DonC used to authenticate the user. The authentication module AUT transmits the coding data DonC to the first communication terminal TC1, which provides them to the user, for example by displaying them on a screen in the form of an image showing the match between two sets of digits.

In step E5, the authentication module AUT transmits a command to the second communication terminal TC2 in order to invite the user to enter a set of data EnsD that matches the secret data DonS. The second communication terminal TC2 interprets this command, for example, by means of an application run in the background, and invites the user to enter a set of data EnsD via a graphical interface. For example, the second terminal comprises a touchscreen on which is displayed a number pad, with the user being able to enter a code that matches the secret data DonS by using the coding data DonC displayed on the first communication terminal TC1.

The second communication terminal TC2 then transmits the set of data EnsD to the authentication server SAuth.

Steps E4 and E5 may be executed at roughly the same time, or the order of steps E4 and E5 may potentially be reversed, with the authentication server SAuth first transmitting a command to the second terminal then the coding data to the first terminal, before the user enters the set of data.

In step E6, the authentication server SAuth compares the set of data EnsD entered by the user and transmitted by the second communication terminal TC2 with the secret data DonS based on the coding data DonC previously generated and transmitted to the first communication terminal TC1.

The authentication server SAuth allows access to the service delivered by the application server SApp if the set of data EnsD matches the secret data DonS.

By way of illustrative examples, four example embodiments are described with reference to FIGS. 3A, 3B, 3C and 3D.

With reference to FIG. 3A, an authentication method is carried out during which an identifier IdU is explicitly provided by the user and the two communication terminals are implicitly paired. It is assumed that the first terminal TC1 and the second terminal TC2 are within the reach of the user, and that the authentication server SAuth has in its memory a match between a user identifier IdU and an identifier IdTC1 of the first terminal.

In a step 3A1, the user transmits his or her user identifier IdU from the second terminal TC2 to the authentication server SAuth, which identifies the premier terminal TC1.

In a step 3A2a, the authentication server SAuth transmits a virtual keyboard to be displayed on the second terminal TC2, as well as a command inviting the user to enter the secret information.

In a step 3A2b, the authentication server SAuth transmits the coding data to be displayed on the terminal TC1.

In a step 3A3, the user enters a set of data matching the secret data on the virtual keyboard of the second terminal TC2. This set of data is then transmitted to the authentication server SAuth, which checks the validity of the set of data.

With reference to FIG. 3B, an authentication method is carried out, during which the two communication terminals are implicitly paired with the help of a temporary identifier.

In step 3B1, from the first terminal TC1, the user requests a temporary identifier from the authentication server SAuth.

In step 3B2, the authentication server SAuth generates a temporary identifier and transmits it to the first terminal TC1.

In step 3B3, the user wishes to use the temporary identifier from the second terminal TC2. In one embodiment, the user takes a photo of the temporary identifier from the second terminal TC2, for example a smartphone, and retrieves the temporary identifier in order to use it from the second terminal. It is assumed that the first terminal and the second terminal do not communicate with one another, in order to avoid any security problems.

In step 3B4, the user transmits the temporary identifier to the authentication server SAuth from the terminal, the server SAuth being capable of performing pairing with the terminal.

In step 3B5a, the authentication server SAuth transmits a virtual keyboard to be displayed on the second terminal TC2, as well as a command inviting the user to enter the secret information.

In step 3B5b, the authentication server SAuth transmits the coding data to the first terminal TC1.

With reference to FIG. 3C, an authentication method is carried out, during which the two communication terminals are implicitly paired with the help of a temporary identifier. The user provides an identifier of the second terminal, which is not within reach of the user, for example a wide-screen terminal in a public place.

In step 3C1, from the first terminal TC1, the user requests a temporary identifier from the authentication server SAuth.

In step 3C2a, the authentication server SAuth generates a temporary identifier and transmits it to the first terminal TC1.

In step 3C2b, the authentication server SAuth transmits the temporary identifier to the second terminal TC2. This enables the user to verify that he or she is in possession of the desired second terminal.

The authentication is then executed as in the previous example; the authentication server SAuth transmits a virtual keyboard to be displayed on the second terminal TC2, as well as a command inviting the user to enter the secret information, and the authentication server SAuth transmits the coding data to the first terminal TC1

With reference to FIG. 3D, an authentication method is carried out, during which the user requests a code for “on-demand” pairing. The code may be a code in and of itself, or a code combined with a URL address (“Unified Resource Locator”).

In step 3D1, the user transmits his or her user identifier IdU from the second terminal TC2 to the authentication server SAuth and requests a code from that server.

In step 3D2, the authentication server SAuth transmits a virtual keyboard to display on the second terminal TC2, as well as a command inviting the user to enter the secret information, and also transmits the previously requested code.

In step 3D3, the user wishes to use the code retrieved from the first terminal TC1. In one embodiment, the user takes a photo of the temporary identifier from the second terminal TC1, for example a smartphone, and retrieves the temporary identifier in order to use it from the first terminal.

In step 3D4, from the first terminal TC1, the user provides a code to the authentication server SAuth. The authentication server SAuth makes an explicit link between the user and the two terminals TC1 and TC2.

In step 3D5, the authentication server SAuth transmits the coding data to the first terminal TC1.

The invention described here relates to a method and a server for an authentication of a user. According to one embodiment of the invention, the steps of the inventive method are determined by the instructions of a computer program incorporated into a server, such as the server SAuth. The program comprises program instructions that, when said program is loaded and executed within the server, carry out the steps of the inventive method.

Consequently, the invention also applies to a computer program, particularly a computer program on or within an information medium, suitable to implement the invention. This program may use any programming language, and be in the form of source code, object code, or intermediate code between source code and object code, such as in a partially compiled form, or in any other form desirable for implementing the inventive method.

1-11. (canceled)

12. A method for authentication, the method comprising the steps of:
receiving a user identifier communicated from a first communication terminal;
identifying a second communication terminal based on the user identifier;
generating coding data;
transmitting the coding data to a first receiving communication terminal, the first receiving communication terminal being one of the first and second communication terminals;
transmitting a command to a second receiving communication terminal to prompt provision of a set of data using the coding data, the second receiving communication terminal being the other one of the first and second communication terminals; and
comparing the set of data provided from the second receiving communication terminal with secret data based on the coding data to provide authentication for service access via the first communication terminal.

13. The method of claim 12, wherein the step of identifying comprises using a previously saved association between the user identifier and an identifier of the second communication terminal.

14. The method of claim 12, wherein the step of identifying comprises using additional information received with the user identifier to identify the second communication terminal.

15. The method of claim 12, further comprising the steps of:
receiving an initial user identifier from the second communication terminal;
generating a temporary user identifier; and
transmitting the temporary user identifier to the second communication terminal, wherein the temporary user identifier is used in place of the user identifier in the step of receiving a user identifier.

16. The method of claim 12, further comprising the steps of:
receiving a second communication terminal identifier from the second communication terminal;
generating a temporary user identifier based on an association between a user identity and the second communication terminal identifier; and
transmitting the temporary user identifier to the second communication terminal, wherein the temporary user identifier is used in place of the user identifier in the step of receiving a user identifier.

17. The method of claim 12, wherein the coding data defines a relationship between between two sets of characters.

18. The method of claim 12, wherein the coding data changes when a predetermined number of characters has been provided by the second receiving communication device.

19. The method of claim 12, wherein the coding data is transmitted in text form.

20. The method of claim 12, wherein the coding data is transmitted in table form.

21. The method of claim 12, wherein the coding data is transmitted in image form.

22. The method of claim 12, wherein the coding data is transmitted in voice form.

23. The method of claim 12, wherein the secret data is a password.

24. An authentication server, comprising:
means for receiving a user identifier communicated from a first communication terminal;
means for identifying a second communication terminal based on the user identifier;
means for generating coding data;
means for transmitting the coding data to a first receiving communication terminal, the first receiving communication terminal being one of the first and second communication terminals;
means for transmitting a command to a second receiving communication terminal to prompt provision of a set of data using the coding data, the second receiving communication terminal being the other one of the first and second communication terminals; and
means for comparing the set of data provided from the second receiving communication terminal with secret data based on the coding data to provide authentication for service access via the first communication terminal.

25. A computer program capable of being implemented within a server for performing authentication, the computer program comprising instructions that, when the program is loaded and executed in the server, carries out the steps comprising of:
receiving a user identifier communicated from a first communication terminal;
identifying a second communication terminal based on the user identifier;
generating coding data;
transmitting the coding data to a first receiving communication terminal, the first receiving communication terminal being one of the first and second communication terminals;
transmitting a command to a second receiving communication terminal to prompt provision of a set of data using the coding data, the second receiving communication terminal being the other one of the first and second communication terminals; and
comparing the set of data provided from the second receiving communication terminal with secret data based on the coding data to provide authentication for service access via the first communication terminal.
